(19) United States
(12) Patent Application Publication
(10) Pub. No.: US 2017/0039774 A1
(43) Pub. Date: Feb. 9, 2017

(54) Augmented Reality Communications

(71) Applicant: Tremolant Inc., Gatineau (CA)

(72) Inventor: Luis Pablo ESTABLE, Gatineau (CA)

(73) Assignee: Tremolant Inc., Gatineau, QC (CA)

(21) Appl. No.: 15/304,103

(22) PCT Filed: Apr. 14, 2015
(86) PCT No.: PCT/CA2015/050310

§ 371 Date: Oct. 14, 2016

Related U.S. Application Data
(60) Provisional application No. 61/979,506, filed on Apr. 14, 2014.

(51) Int. Cl. G06T 19/00; G09G 5/00; G02B 27/01; H04N 13/02; H04N 13/04; G06T 7/00; G06F 3/01

(52) U.S. Cl. CPC G06T 19/006; G06T 7/0085; G09G 5/006; G06F 3/012; H04N 13/0239; H04N 13/044; G02B 27/017; G09G 2370/16; G02B 2027/0138; G02B 2027/014; G02B 2027/0178; G02B 2027/0132

(57) ABSTRACT

Disclosed herein is a method of augmented reality communications involving at least one ar-computer connected to ar-eyewear having an ar-camera and an ar-display, as well as an ar video communication system suitable for augmented reality communications over a data-communications-network. The method comprising the acts of determining at least one data structure that delimits at least one portion of a field of view onto the surface of a mirror; if the at least one data structure includes an ar-bound-box, then selecting the ar-camera video using the ar-bound-box and sending a formatted-ar-camera-video using the ar-bound-box; and if the at least one data structure includes an ar-video-overlay, then receiving a received-video and displaying the received-video in the ar-video-overlay. The system includes: an ar-eye-wear including at least one ar-display, and at least one ar-camera; an ar-computer including at least an ar-video-communications-module and other-modules, the ar-computer connected with the ar-eyewear so as to enable the ar-video-communications-module and other modules to use the ar-display and the ar-camera. The ar-video-communications-module is configured for at least one of determining an ar-bound-box, selecting ar-camera video using an ar-bound-box, sending formatted-ar-camera-video, receiving video, determining an ar-video-overlay, and displaying video in an ar-video-overlay.

### TECHNICAL FIELD

The present application relates to augmented reality and, more particularly, to augmented reality communication techniques.

### BACKGROUND ART

According to Wikipedia, Augmented Reality (AR) is a live direct or indirect view of a physical, real-world environment whose elements are augmented (or supplemented) by computer-generated sensory input such as sound, video, graphics or GPS data. Hardware components for augmented reality are: processor, display, sensors and input devices. Modem mobile computing devices like smartphones and tablet computers contain these elements which often include a camera and MEMS sensors such as accelerometer, GPS, and solid state compass, making them suitable AR platforms. AR displays can be rendered on devices resembling eyeglasses, hereinafter AR eye wear. Versions include eye wear that employ cameras to intercept the real world view and re-display its augmented view through the eye pieces and devices in which the AR imagery is projected through or reflected off the surfaces of the eye wear lens pieces. Google Glass is not intended for an AR experience, but third-party developers are pushing the device toward a mainstream AR experience. After the debut of Google Glass many other AR devices emerged such as but not limited to Vuzix M100, Optinvent, Meta Space Glasses, Telepathy, Recon Jet, Glass Up, K-Gass, Moverio BT-200, and Microsoft Hololens. Some of the AR eye war offers the potential to replace other devices a user typically has to carry with them, such as for example, their mobile device (e.g. computer, tablet, smart phone, etc.). The Meta Space Glasses for example proposes to mirror devices in AR form such that they would appear in front of the wearer of the AR eye wear. Networked data communications enable the display of the user interface of the devices into 3D models of the device housings. Interaction between the AR form of the devices and the wearer of the AR eye wear is turned into user input which is relayed to the actual device via the networked data communications. Similarly, the result of any such interactions, or any updates of the user interface of the devices, is communicated to be rendered by the AR eye wear thereby enabling the AR form of the devices to look and operate substantially like the real devices. Advantageously, the devices themselves can remain in a secure location such that the wearer of the AR eye wear need only carry the AR eye wear and leave every other device behind. AR eye wear therefore have the potential to become the ultimate in mobile technology as the user may be able to carry the AR eye wear and nothing else.

A problem that such an arrangement presents is that it is not possible to utilise the camera functionality of the AR form of devices having cameras integrated to them. For example, if a mobile device has a camera, the user of the same mobile device in AR form via their AR eye wear will not be able to use the front fading camera for such purposes as, for example video communication such as video conferencing or video chat: if the camera of the real device is enabled using a video conferencing or video chat application, the camera will be recording what it sees at the remote location, and not the location whereat the user of the AR form via their AR eye wear

A possible solution to the problem of using AR eye wear for video communication is the employment of a separate physical camera in conjunction with the AR eye wear. A possible solution to the problem of using AR eye wear for video communication is the use of the existing AR eye wear camera for video communication. Using a separate physical camera in conjunction with an AR eye wear for video communication has the inconvenience of requiring one to carry an additional device that needs to be in communication with the AR eye wear. Using the camera in the AR eye wear for video communication is promising, but it presents some additional challenges. For example, since these cameras face away from the wearer of the AR eye wear, the wearer may not be able to simultaneously view the user interface (including video communications from another party) at the same time as they capture their own image: currently the user of the AR eye wear would have to remove the AR eye wear to point the camera toward themselves in order to direct the camera to their own face for video communication. A similar problem occurs if users of an AR eye wear wishes to use a conventional video communications application such as Skype or the like: the other party sees what the AR eye wear user is seeing, and not the AR eye wear user himself.

There is therefore a need for techniques of employing the camera functionality that is built in to the AR eye wear to enable the wearer to participate in video communication without the need of any additional communications to an additional external device with the AR eye wear, and without the need of removing the AR eye wear to direct the camera in the AR eye wear to their own face.

### DISCLOSURE OF INVENTION

### Summary

According to one aspect of the present application, there is provided a method of augmented reality communications involving at least one ar-computer connected to ar-eyewear having an ar-camera and an ar-display. The method comprising the acts of: determining at least one data structure that delimits at least one portion of a field of view onto the surface of a mirror; if the at least one data structure includes an ar-bound-box, then selecting the ar-camera video using the ar-bound-box and sending a formatted-ar-camera-video using the ar-bound-box; and if the at least one data structure includes an ar-video-overlay, then receiving a received-video and displaying the received-video in the ar-video-overlay. Some embodiments further include pre-steps to one of the acts of sending or receiving, including at least one of signalling to establish a communications path between end points, configure ar-markers, configure facial recognition, configure camera calibration, and configure relative position of user interface elements. In some embodiments, the ar-bound-box delimits the portion of the field of view of the ar-camera that will be utilised to send the formatted-ar-camera-video. In some embodiments, the data structure is determined automatically by recognizing at the ar-computer using the ar-camera, one of: a reflection of the face of a user in a mirror, a reflection of the ar-eyewear in a mirror, and an ar-marker. In some embodiments, the data structure is determined manually by user manipulation of the information displayed in the ar-display including at least one of grab, point, pinch and swipe. Some embodiments, further include the step of formatting the ar-camera video including at least one of correcting for alignment of a mirror with the ar-camera and cropping the ar-camera video to include the portion that is delimited by the ar-bound-box. In some embodiments, at least a portion of the data-structure is positioned on the surface of a mirror. In some embodiments, the ar-video-overlay is dimensioned and positioned relative to a user of the ar-eyewear. Some embodiments further include post-steps to one of the acts of sending or receiving, including at least one of terminating the video communication, terminating the communication path between the end points, reclaiming resources, storing preferences based on one of location, ar-marker, data used, and ar-bound-box.

According to another aspect of the present application, there is provided an ar video communication system suitable for augmented reality communications over a data-communications-network. The system includes: an ar-eye-wear including at least one ar-display, and at least one ar-camera; an ar-computer including at least an ar-video-communications-module and other-modules, the ar-computer connected with the ar-eyewear so as to enable the ar-video-communications-module and other modules to use the ar-display and the ar-camera. The ar-video-communications-module is configured for at least one of determining an ar-bound-box, selecting ar-camera video using an ar-bound-box, sending formatted-ar-camera-video, receiving video, determining an ar-video-overlay, and displaying video in an ar-video-overlay. In some embodiments, the ar-eyewear further comprises at least one of a frame, a second ar-display, a left lens, a right lens, a sound-sensor, a left speaker, a right speaker, and a motion sensor. In some embodiments, the ar-camera includes at least one of a camera and a depth-camera. In some embodiments, the ar-computer further comprises at least one of a CPU, a GPU, a RAM, a storage drive, and other modules. In some embodiments, the ar-video-communications-module provides a conventional camera device driver to enable applications operating in the ar-computer to use a mirror-camera as if it were a real-world camera.

Other aspects of the present application will become apparent to a person of ordinary skill in the art to which they pertain in view of the accompanying drawings and their description.

### BRIEF DESCRIPTION OF DRAWINGS

### Description of Drawings

A complete understanding of the present application may be obtained by reference to the accompanying drawings, when considered in conjunction with the subsequent, detailed description, in which:

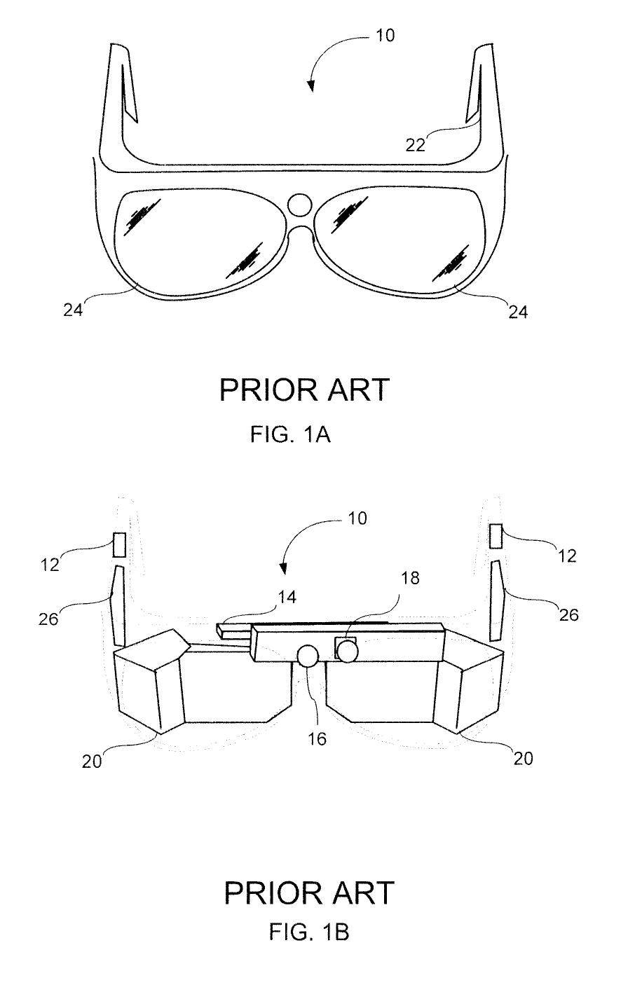

FIG. 1 is a front view of (A) a prior-art AR eye wear and (B) components in the prior-art AR eye wear;

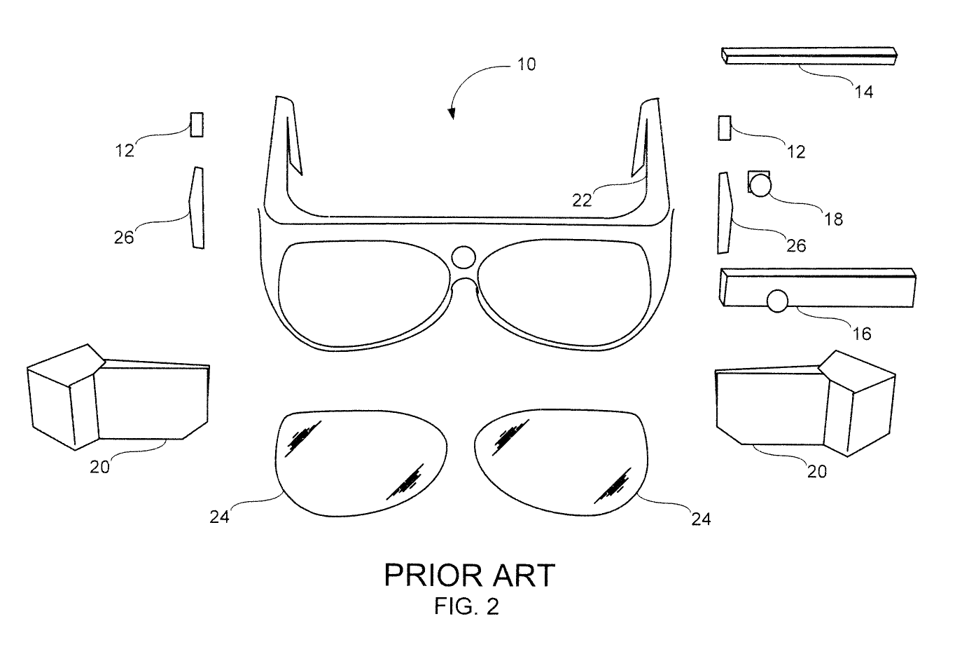

FIG. 2 is an exploded view of the prior art AR eye wear of FIG. 1;

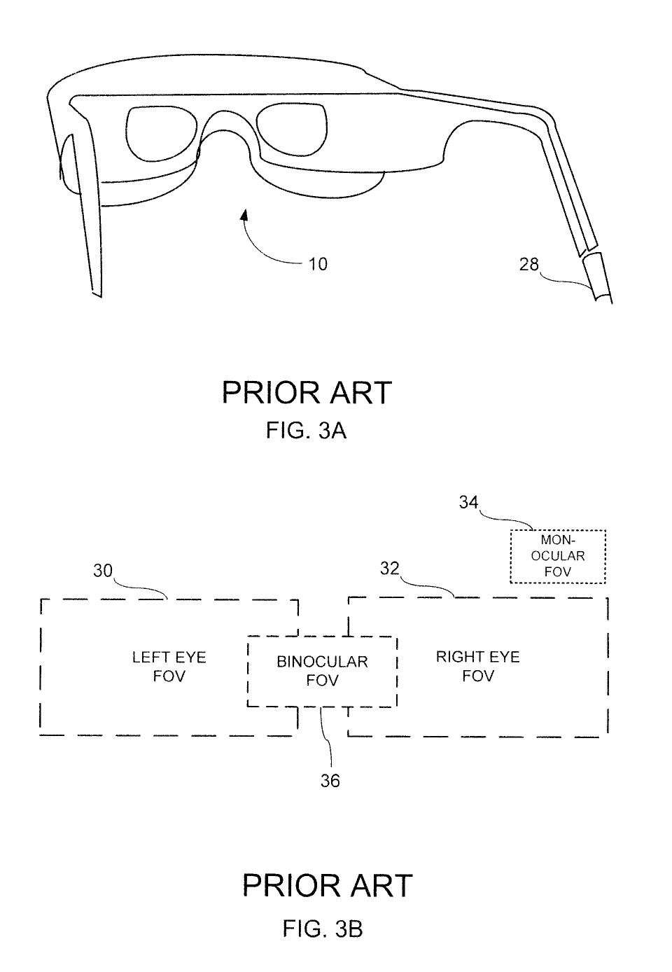

FIG. 3 is (A) a rear view of the prior art AR eye wear of FIG. 1 and (B) a front view of the stereoscopic field of view of the prior art AR eye wear of FIG. 1 in comparison to a monocular prior art field of view;

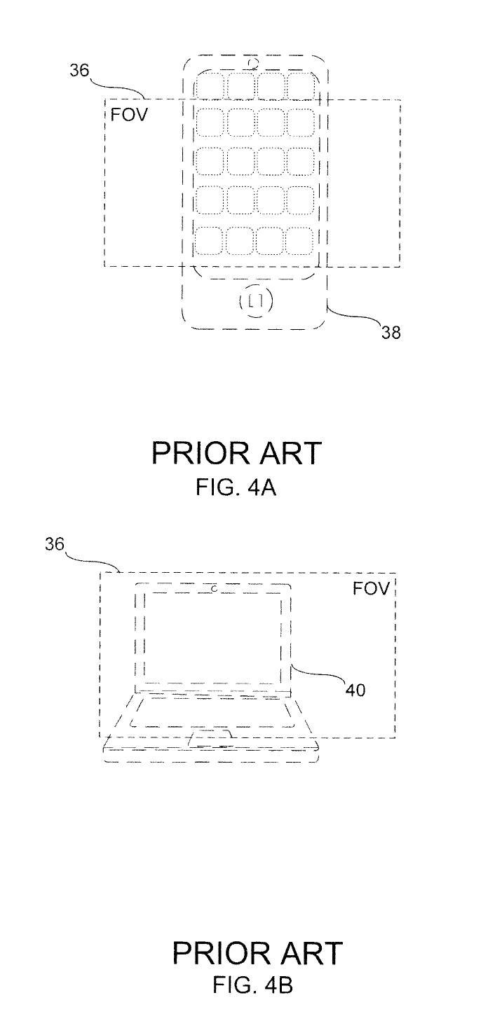

FIG. 4 is a front view of a prior art AR form of (a) a smartphone and (b) a laptop, each as seen through the prior art AR eye wear of FIG. 1;

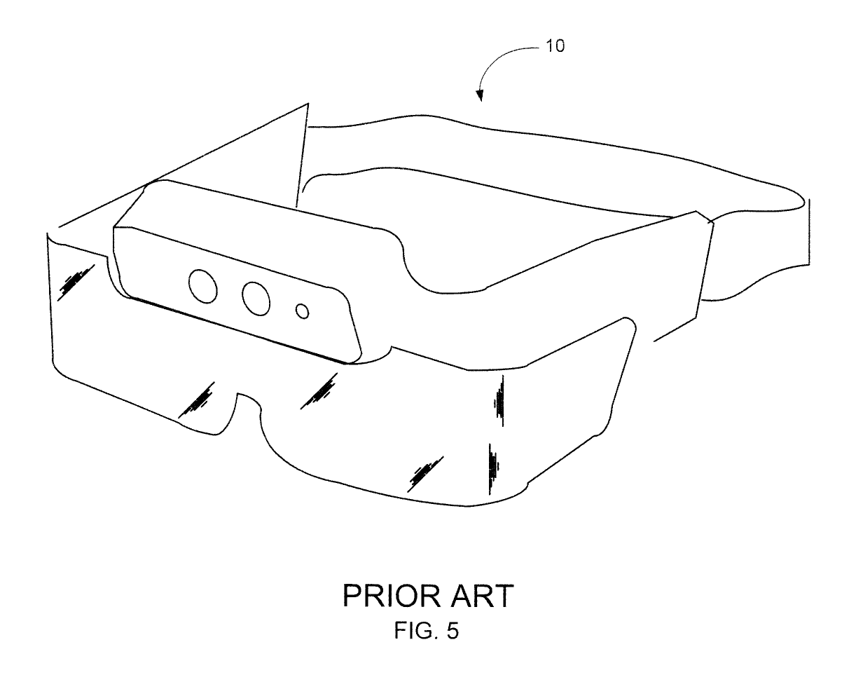

FIG. 5 is a perspective view of a prior art AR eye wear;

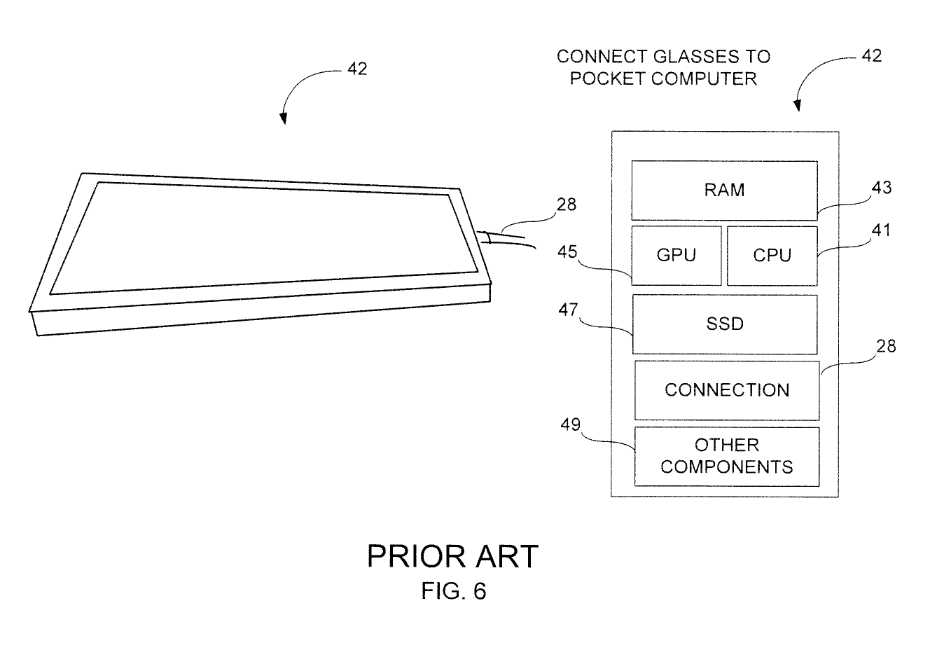

FIG. 6 is a detail view of a prior art pocket computer that co-operates with the prior art of FIGS. 1-4;

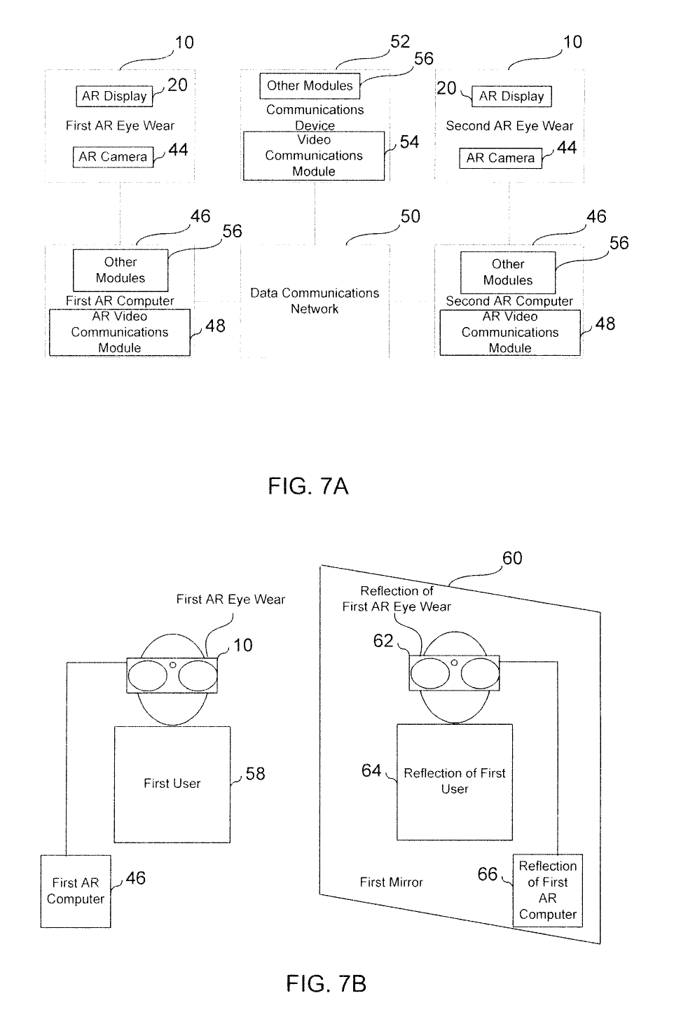

FIG. 7 is a block diagram view of (A) an AR video communication system provided in accordance with an embodiment of the present application and (B) a first mirror used in conjunction with the first AR eye wear and first AR computer provided in accordance with an embodiment of the present application;

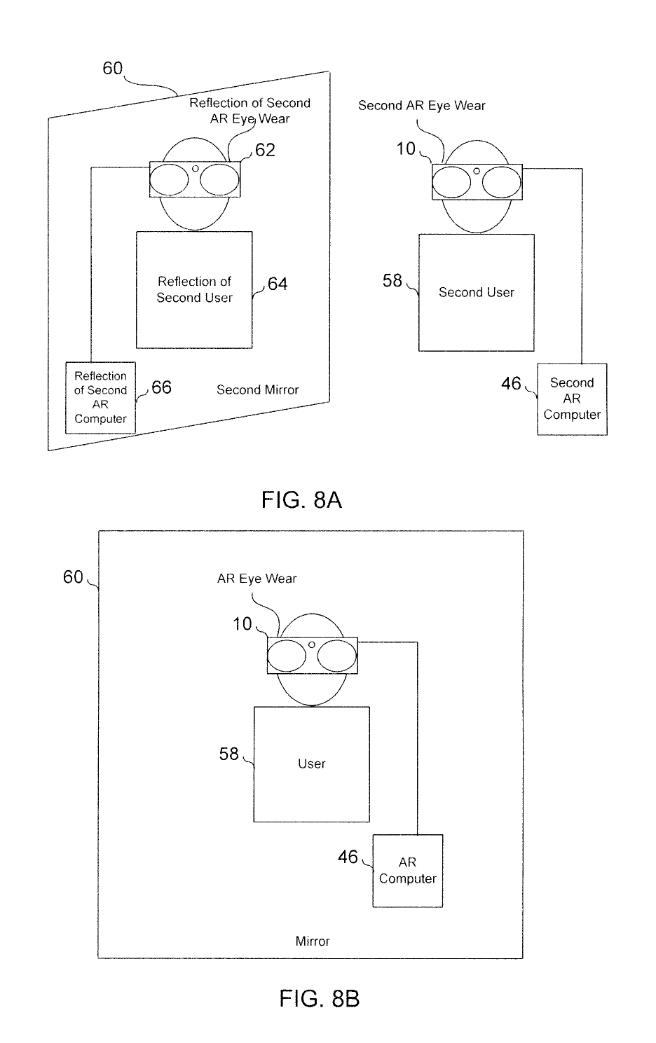

FIG. 8 is a block diagram view of (A) a second mirror used in conjunction with the second AR eye wear and second AR computer provided in accordance with an embodiment of the present application and (B) what a users may see in the mirror provided in accordance with an embodiment of the present application;

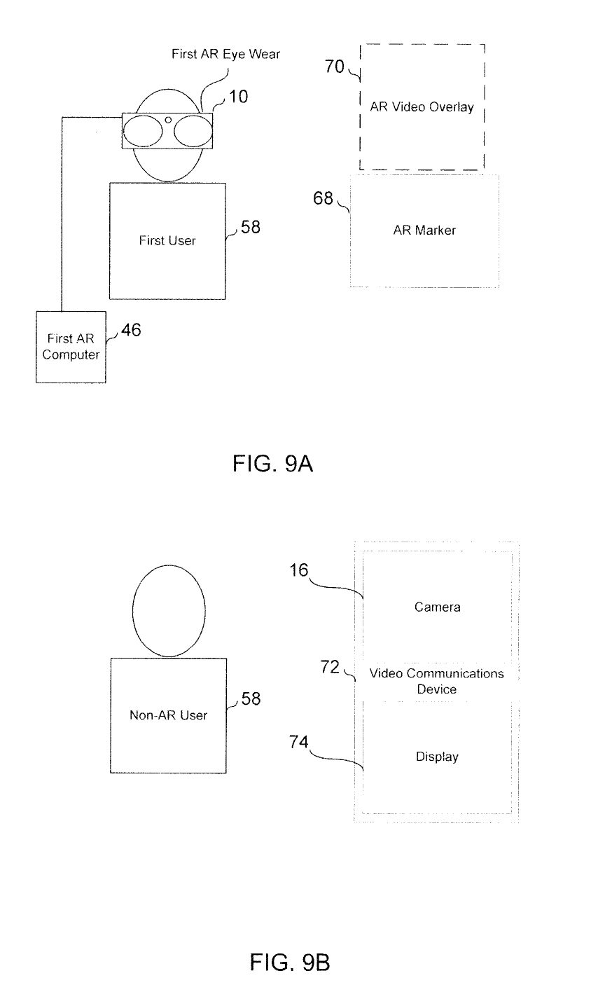

FIG. 9 is a block diagram view of a (A) first user wearing a first AR eye wear and using a first AR computer to display an AR video overlay over an AR marker provided in accordance with an embodiment of the present application, and (B) a non-AR user using a video communication device provided in accordance with an embodiment of the present application;

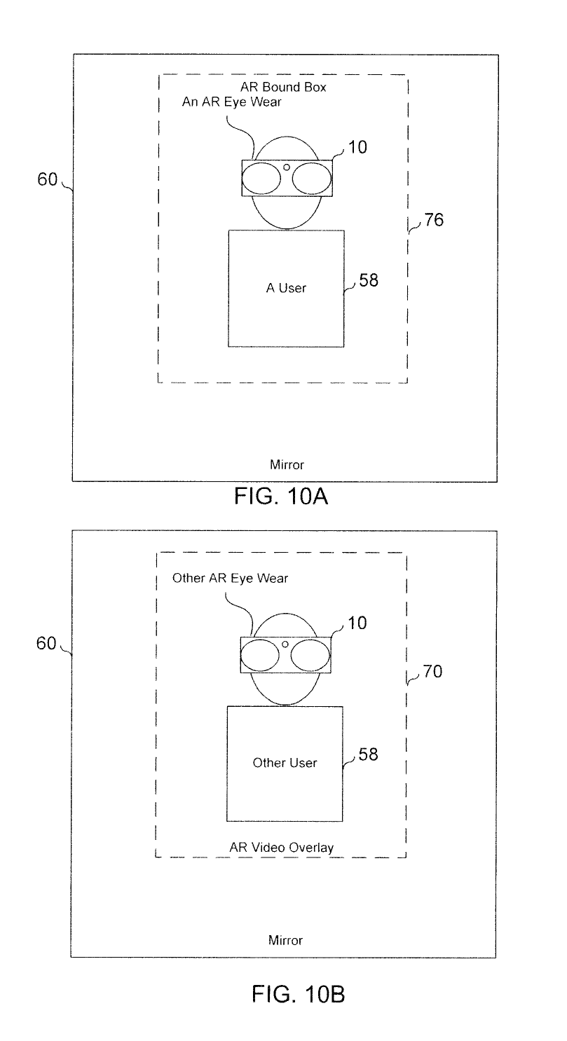

FIG. 10 is a block diagram view of an (A) AR bound box around the reflection of a user in a minor as seen by a user of an AR eye wear provided in accordance with an embodiment of the present application and (B) an AR video overlay displaying an image of an other user wearing an other AR eye wear as seen by the a user wearing an AR eye wear provided in accordance with an embodiment of the present application;

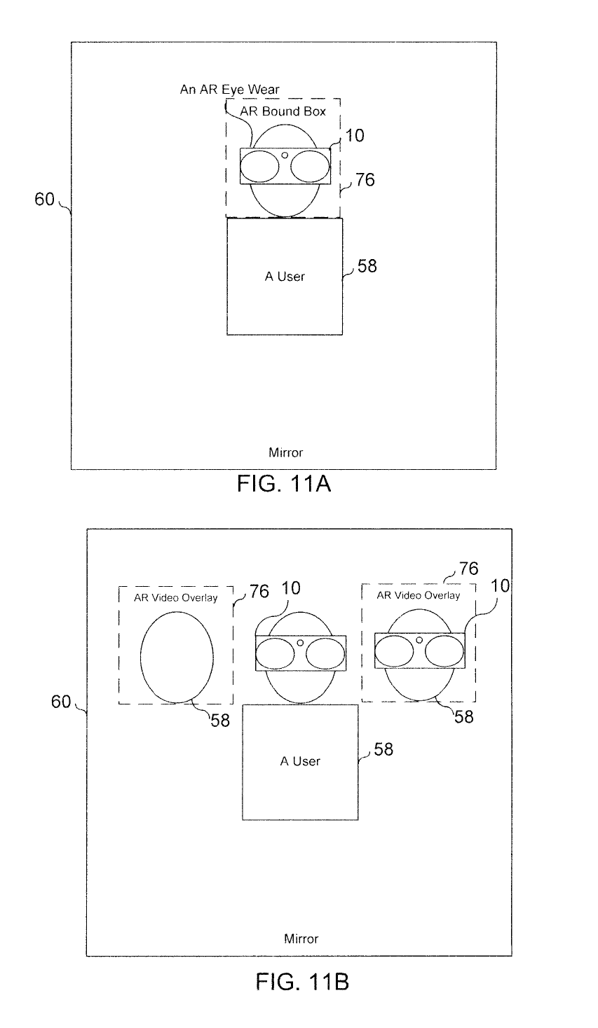

FIG. 11 is a block diagram view of (A) an AR bound box around the reflection of a user in a mirror as seen by a user of an AR eye wear provided in accordance with an embodiment of the present application and (B) two AR video overlay displaying an image of two other users, one wearing an other AR eye wear and the other not wearing any AR eye wear, as seen by a user wearing an AR eye wear provided in accordance with an embodiment of the present application;

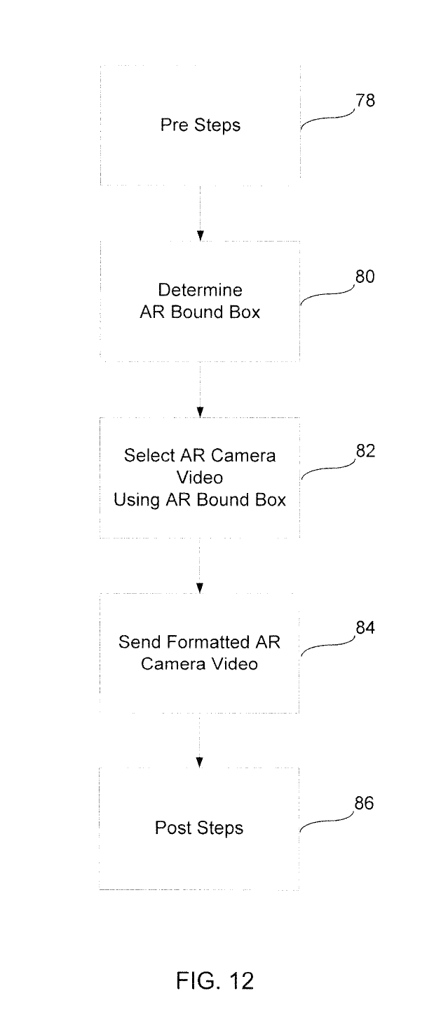

FIG. 12 is a flowchart view of acts taken to capture and send video communications using an AR eye wear provided in accordance with an embodiment of the present application;

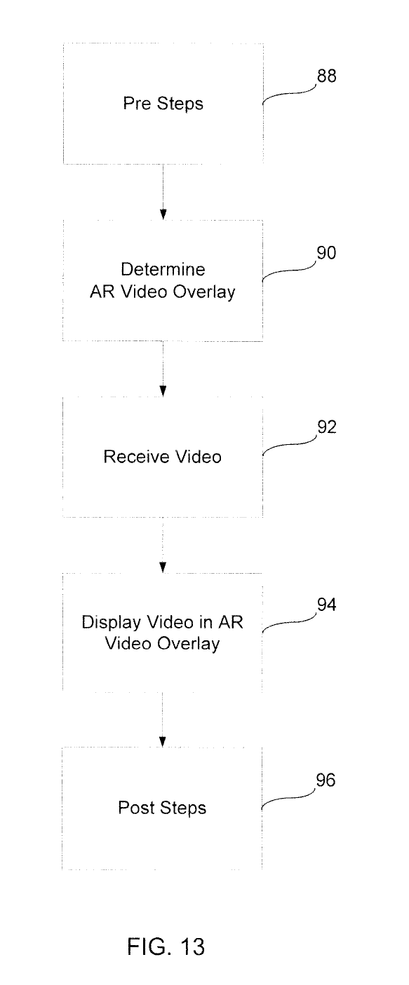

FIG. 13 is a flowchart view of acts taken to receive and display video communications using an AR eye wear provided in accordance with an embodiment of the present application;

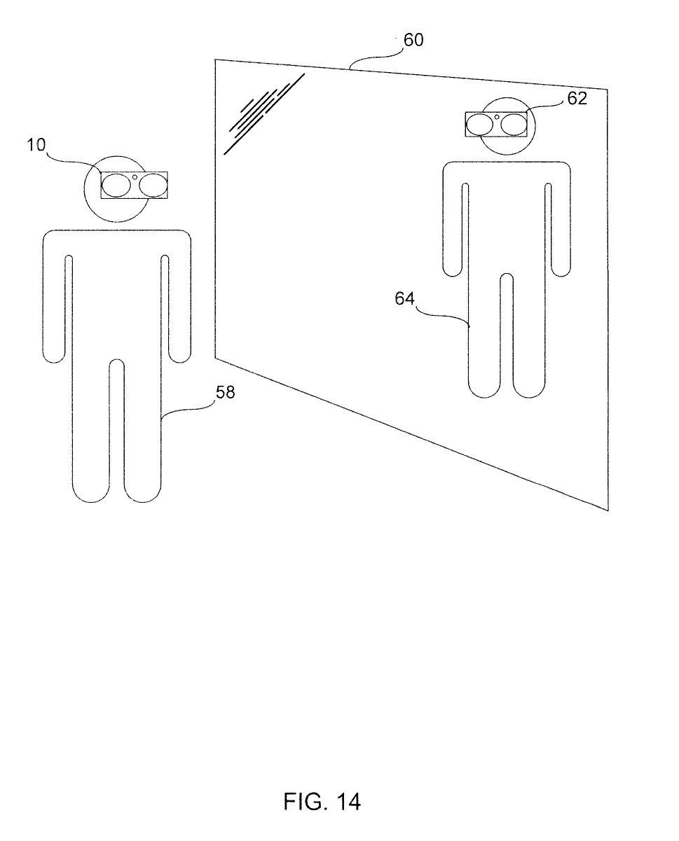

FIG. 14 is a front perspective view of a FIG. 7B;

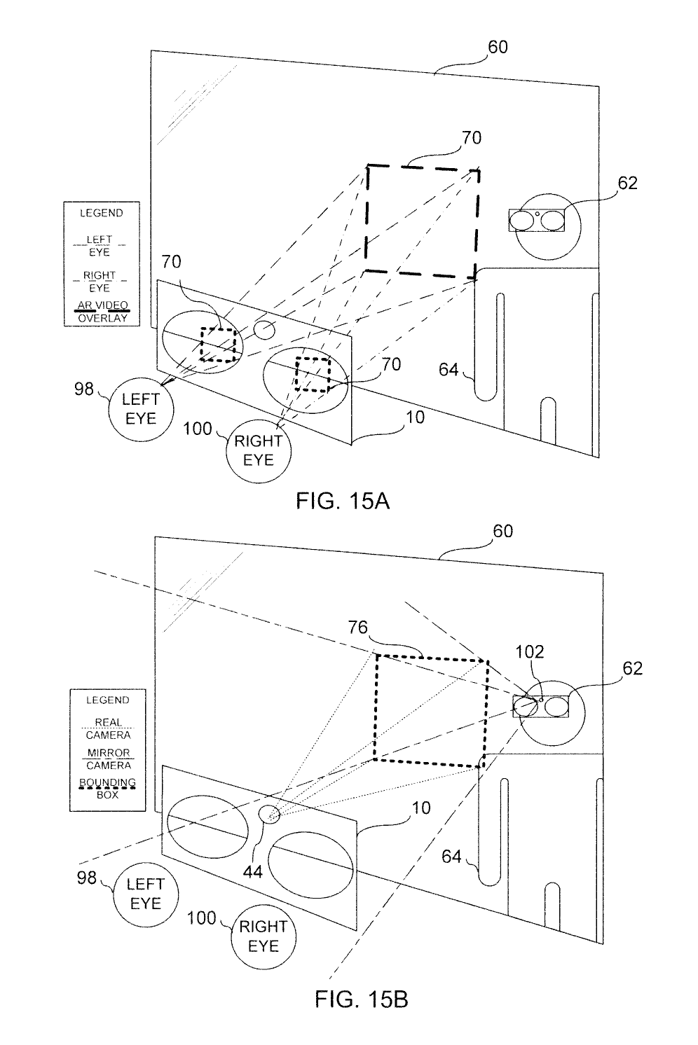

FIG. 15 is a front perspective view of an of FIG. 10 illustrating how a rectangular portion of a mirror is seen as: (A) an ar video overlay by a left eye and a right eye through the ar displays of ar eyewear and (B) an ar bound box by the real camera and a mirror camera; and

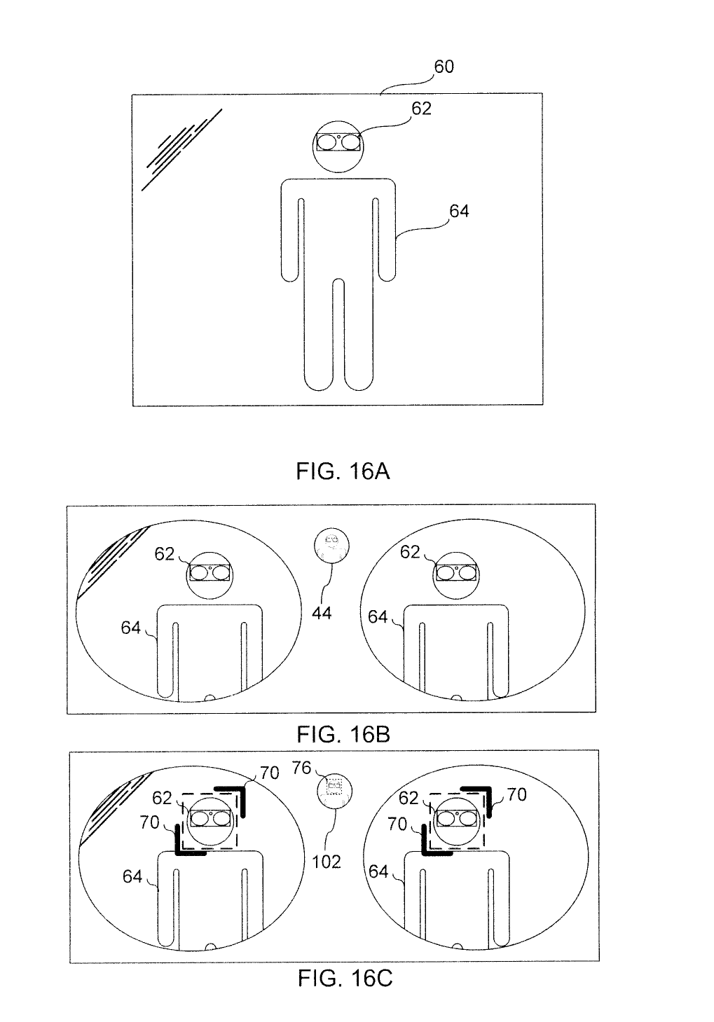

FIG. 16 is a front view of a (A) the mirror of FIG. 14, (B) the left eye, right eye, and a real camera view; and (C) an augmented left eye, right eye, and mirror camera view.

For purpose of clarity and brevity, like elements and components will bear the same designations throughout the Figures.

FIGS. 1-6 are representative of the state of the prior art described and illustrated at https://web.archive.org/web/20140413125352/https://vvww.spaceglasses.com/ as archived on Apr. 13, 2014, which is incorporated herein by reference in its entirety. FIG. 1 is a front view of a prior-art ar eye wear; FIG. 2 is an exploded view of the prior art ar eye wear of FIG. 1; FIG. 3 is a rear view of the prior art ar eye wear of FIG. 1 and a front view of the binocular (stereoscopic) field of view of the prior art ar eye wear of FIG. 1 in comparison to a monocular prior art field of view; FIG. 4 is a front view of the prior art ar form of (A) a smart phone and (B) a laptop, each as seen through the prior art ar eye wear of FIG. 1; FIG. 5 is a perspective view of a prior art ar eye wear; FIG. 6 is a detail view of a prior art pocket computer 42 that co-operates with the prior art of FIGS. 1-4. The pocket computer 42 includes CPU 41, RAM 43, GPU 45, SSD 47, Other components 49 and Connection 28. Examples for these components are a 1.5 GHz Intel i5 (Central Processing Unit) CPU 41, 4 GB of (Random Access Memory) RAM 43, High power (Graphics Processing Unit) GPU 45 and 128 GB (Solid-State Drive) SSD 47 (more generally, could be another form of storage drive). The ar-eyewear 10 includes a frame 22 a left and a right lens 24, sound-sensor 14 (microphone), a left and right speaker 26 (surround sound), motion-sensor 12 (9 axis motion tracking: accelerometer, gyroscope and compass), camera 16 and depth-camera 18 and left and right ar-display 20. The ar-eyewear 10 is connected to the computer 42 via a connection 28. The ar-eyewear 10 and the computer 42 can be two units, or provided in an integrated unit. When looking through ar-eyewear 10 a user 58 can see a left-fov 30 and a right-fov 32 (field of view) with their eyes, as well as a a binocular-fov 36 which can be used to displays stereoscopic information that augments the left-fov 30 and right-fov 32 via the left and right ar-display 20 respectively. A user 58 interface is provided by the computer 42 allowing a user 58 to interact with the computer 42 via the ar-eyewear 10 (e.g. by using the dept-camera 16 and camera 16 as input devices) and in some cases an auxiliary input device such as a touchpad provided on the computer 42. The functionality of the ar-eyewear 10 and computer 42 is embodied in software, e.g. data structures and instructions, created, read, updated, and deleted from SSD 47, RAM 43, Other components 49 by CPU 41, GPU 45, and by the ar-eyewear 10 via Connection 28. In some ar-eyewear 10, there is only one ar-display 20 and only a monocular-fov 34 is possible. It is to be understood that a smartphone can be used as an ar-eyewear 10 that need not be fixed to the user 58. It has been contemplated that using the ar-eyewear 10 and computer 42 a mirrored-phone 38 or mirrored-laptop 40 could be made to appear in the binocular-fov 36 of a user 58 such that the user 58 can operate the mirrored devices in a manner that is substantially the same as if a real device were in front of them. It is contemplated that these mirrored devices could be entirely emulated, or alternatively in communication with real-world physical counterparts. It is clear however that as illustrated, it is not possible to capture images or video of the user 58 of the ar-eyewear 10 using the mirrored-phone 38 or mirrored-laptop 40. Similarly, the user 58 of the ar-eyewear 10 cannot only use conventional video or camera applications operating on computer 42 to capture images of the user while they are wearing the ar-eyewear.

FIG. 7 is a block diagram view of (A) an AR video communication system provided in accordance with an embodiment of the present application and (B) a first mirror 60 used in conjunction with the first ar-eyewear 10 and first ar-computer 46 provided in accordance with an embodiment of the present application. A first and second ar-computer 46, and a communications-device 52 are connected via a data-communications-network 50. In one embodiment, each of the ar-computer 46 are substantially similar to the pocket computer 42 illustrated in FIG. 6, except for at least the ar-video-communication-module 48, and optionally some portions of the other-modules 56, which are provided as software an/or hardware in SSD 47, RAM 43, or via other components 49. It is contemplated that other components 49 could include a holographic processing unit, for example. As shown in FIG. 7A, each of the first and second ar-computer 46 is in communication with a first and second ar-eyewear 10. Each of the first and second ar-eyewear 10 includes an ar-display 20 and an ar-camera 44. In one embodiment, the ar-display 20 and the ar-camera 44 are provided by the prior art ar-eyewear 10 of FIGS. 1-5, except for the effect of any portions of the ar-video-communications-module 54 or other-modules 56. In alternative embodiments, the split between the ar-eyewear 10 and the ar-computer 46 may be different, or may be fully integrated into a single unit. A more conventional communications-device 52 is also illustrated including other-modules 56 and a video-communications-module 54 to illustrate that ar-eyewear 10 users and non-ar-eyewear 10 users are advantageously enabled to have video communications due to embodiments of the present application. The data-communications-network 50 may include various access networks, including wireless access networks, such as cellular and wi-fi access networks or the like, such that the communications between the various blocks may be wireless. As shown in FIG. 7B, a first user 58 wearing a first ar-eyewear 10 connected to a first ar-computer 46. Advantageously, the first ar-eyewear 10 is looking at a first mirror 60 in which the first user 58, and consequently the ar-camera 44 of the first ar-eyewear 10, sees: a reflection of first user 58 (reflection-user 64), a reflection of first ar-eyewear 10 (reflection-ar-eyewear 62), and a reflection of first ar-computer 46 (reflection-ar-computer 66).

FIG. 8 is a block diagram view of a (a) second mirror 60 used in conjunction with the second ar-eyewear 10 and second ar-computer 46 provided in accordance with an embodiment of the present application and (b) what a user 58 may see in the mirror 60 provided in accordance with an embodiment of the present application. As shown in FIG. 8A, a second user 58 wearing a second ar-eyewear 10 connected to a second ar-computer 46. Advantageously, the second ar-eyewear 10 is looking at a second mirror 60 in which the second user 58, and consequently the ar-camera /1′1 of the second ar-eyewear 10, a reflection of second user 58, a reflection of second ar-eyewear 10, and a reflection of second ar-computer 46. As shown in FIG. 8B, the reflection that a user 58 sees includes an ar-eyewear 10, the user 58, and an ar-computer 46. The mirrors in the drawings of this application are for illustrative purposes only. In alternate embodiments, the mirrors may be household mirrors, car mirrors, mirrored siding of a building, a compact mirror 60, a shiny chrome surface, a glass surface or more generally any surface that reflects at least a portion of the image of the user 58 of an ar-eyewear 10 and/or the ar-eyewear 10 such that it can be captured with the ar-camera 44 in the ar-eyewear 10. In one embodiment, a mirror 60 is provided by an application operating on a device such as a tablet, a smartphone, a computer 42 or any other device capable of providing an observer with an image. In the case of a tablet, smartphone or computer 42, the use of a forward facing camera 16 provided on the tablet, smartphone or computer 42 can provide the user 58 of the ar-eyewear 10 with the equivalent of a mirror 60. There need not be a communications path between the tablet, smartphone or computer 42 in such an embodiment as those devices would be used as a mirror 60. Mirror 60 applications are available, for example, on smartphones and tablets, and the camera 16 application of those devices, when configured to use the camera 16 on the same surface as the display 74, is another way to provide a mirror 60 in accordance with the present application.

FIG. 9 is a block diagram view of a (A) first user 58 wearing a first ar-eyewear 10 and using a first ar-computer 46 to display 74 an ar-video-overlay 70 over an ar-marker 68 provided in accordance with an embodiment of the present application, and (B) a non-ar user 58 using a video-communication-device provided in accordance with an embodiment of the present application. As shown in FIG. 9A, an ar-marker 68 is provided in order to facilitate the positioning of the ar-video-overlay 70 in which video communications are displayed. In one embodiment, an image of the ar-eyewear 10 is used for the ar-marker 68, such that, when first user 58 looks at himself in the mirror 60, the ar-video-overlay 70 is position Ned automatically in relation to the reflection of the ar-eyewear 10. In absence of a mirror 60, an ar-marker 68 can be provided on paper or on an electronic display 74 device. In another embodiment, the ar-marker 68 is an image that the user 58 of the first ar-eyewear 10 takes using the ar-eyewear 10 ar-camera ¹/₁ such that there is no need for a paper ar-marker 68. Suitable images could be a painting on a wall, or any other item that would distinguish from the background and provide a reference location for displaying the ar-video-overlay 70, such as for example the reflection of the face of the user 58 in the mirror 60 recognized through facial recognition. As shown in FIG. 9B, a non-ar user 58 utilises a video-communications-device 72 having a conventional camera 16 and display 74 to participate in video communications with the first and/or second user 58. Although not shown in the drawings, in some embodiments, a mobile device such as a smartphone or tablet can be used to provide a combined ar-eyewear 10 and ar-computer 46, whereby holding the smartphone or tablet near the user's face without fully obscuring it in front of a mirror 60 would enable augmenting the video that the user 58 sees to include an ar-video-overlay 70. In some embodiments, the ar-marker 68 of FIG. 9A is an image of a smartphone or a tablet.

FIG. 10 is a block diagram view of a (A) an ar-bound-box 76 around the reflection of a user 58 in a mirror 60 as seen by a user 58 of an ar-eyewear 10 provided in accordance with an embodiment of the present application and (B) an ar-video-overlay 70 displaying an image of an other user 58 wearing an other ar-eyewear 10 as seen by a user 58 wearing an ar-eyewear 10 provided in accordance with an embodiment of the present application. As shown in FIG. 10A, an ar-bound-box 76 is displayed in the field of view of a user 58 as seen through the ar-eyewear 10. The ar-bound-box 76 can be either dimensioned automatically in proportion to the scale of the ar-eyewear 10 (e.g. recognizing the image for the ar-eyewear 10 reflection as an ar-marker 68), or manipulated by the user 58 by performing grab, point, pinch switpe etc. (actions one would use on real world objects), that the other-modules 56 in the ar-computer 46 are configured to recognize and relay to the ar-video-communications-module 54. The purpose of the ar-bound-box 76 is to delimit the area of the field of view of the ar-camera 44 that will be used by the ar-video-communications-module 54. As shown in FIG. 10B, an ar-video-overlay 70 is displayed in the field of view of a user 58 as seen through the ar-eyewear 10. The ar-video-overlay 70 in this embodiment overlaps with the ar-bound-box 76 such that the reflection of the user 58 is augmented by replacing with video received by the ar-video-communications-module 54. As illustrated, the ar-video-overlay 70 in this instance shows the image of an other user 58 who is also wearing an other ar-eyewear 10.

FIG. 11 is a block diagram view of (A) an ar-bound-box 76 around the reflection of a user 58 in a mirror 60 as seen by a user 58 of an ar-eyewear 10 provided in accordance with an embodiment of the present application and (B) two ar-video-overlay 70 displaying an image of two other users, one wearing an other ar-eyewear 10 and the other not wearing any ar-eyewear 10, as seen by the a user 58 wearing an ar-eyewear 10 provided in accordance with an embodiment of the present application. As shown in FIG. 11A, an ar-bound-box 76 which only covers the face of a user 58 wearing an ar-eyewear 10 is illustrated. In alternative embodiments, the ar-bound-box 76 may include only a portion of a face of a user 58, such as for example, when using the rear view mirror 60 of a car, or a compact mirror 60. As shown in FIG. 11B, although the ar-bound-box 76 of FIG. 11A is being utilized to delimit the area of the filed of view of the ar-camera 44 that will be used by the ar-video-communications-module 54, two separate and disjoint ar-video-overlay 70 are being displayed. The one to the the left of the reflection of a user 58 is for another user 58 that is not wearing an ar-eyewear 10, whereas the ar-video-overlay 70 to the right of the reflection of a user 58 shows another user 58 wearing an ar-eyewear 10. In some embodiments, a self-view is displayed in an ar-video-overlay 70 when the reflection of the user 58 is obscured by an ar-video-overlay 70. In other embodiments, the reflection of the user 58 is omitted. Variations on the position and number of ar-video-overlay 70, as well as their content, would be obvious to a person of skill in the art depending on the application of the techniques of the present application, and thus are considered to have been enabled by the teachings of this application.

FIG. 12 is a flowchart view of acts taken to capture and send video communications using an ar-eyewear 10 provided in accordance with an embodiment of the present application. At the act pre-steps-send 78, optionally some steps can be taken in advance to configure the ar-video-communications-module 54 and other-modules 56. For example, any signalling required to establish a communications path between end points can be performed here, as well as any steps required to configure ar-markers (if used), facial recognition, camera 16 calibration, and relative position of user 58 interface elements. At the act determine-ar-bound-box 80, an ar-bound-box 76 is determined to delimit the portion of the field of view of the ar-camera 44 that will be utilised by the ar-video-communications-module 54. This ar-bound-box 76 may be determined automatically by recognizing the reflected face or ar-eyewear 10 of the user 58 in a mirror 60, by recognizing an ar-marker 68, or may be determined by user 58 manipulation (grab, point, pinch, swipe, etc.) using their hands, or a combination of both. At the act of select-ar-camera-video 82, using ar-bound-box 76, the ar-bound-box 76 previously determined is used to select the portion of the field of view of the ar-camera 44 that will be utilised by the ar-video-communications-module 54. At the act of send-formatted-ar-camera-video 84, the ar-video-communications-module 54 formats (if necessary) the ar-camera 44 data using the ar-bound-box and sends the formatted-ar-camera-video via the data-communications-network 50. Formatting includes for example acts that are known in the art, such as correcting for the alignment of the mirror with the camera, and cropping the video to include only the portion that is delimited by the ar-bound-box. At the act of post-steps-send 86, optionally steps to terminate the video communication are taken, such as terminating the communications path between the endpoints, reclaiming resources, storing preferences based on location or ar-marker 68 data used, ar-bound-box 76, etc.

FIG. 13 is a flowchart view of acts taken to receive and display 74 video communications using an ar-eyewear 10 provided in accordance with an embodiment of the present application. At the act pre-steps-receive 88, optionally some steps can be taken in advance to configure ar-video-communications-module 54 and other-modules 56. For example, any signalling required to establish a communication path between end points can be performed here, as well as any steps required to configure ar-markers (if used), and relative position of user 58 interface elements. At the act determine-ar-video-overlay 90, an ar-video-overlay 70 is dimensioned and positioned relative to the user 58. If a mirror 60 is available, the ar-video-overlay 70 is positioned on the surface of the mirror 60. In some embodiments, the ar-video-overlay 70 may be determined automatically by recognizing the reflected face or ar-eyewear 10 of the user 58 in a mirror 60, by recognizing an ar-marker 68, or may be determined by user 58 manipulation (grab, point, pinch, swipe, etc.) using their hands, or a combination of both. At the act of receive-video 92, the ar-communications-module receives video data from the data-communications-network 50 and formats it (if necessary) such that the ar-display 20 is capable of displaying it. At the act of display-video-in-ar-video-overlay 94, the air-video-communications-module 54 causes the received video to be displayed in the ar-video-overlay 70. In some embodiments, steps 90 and 92 may be reversed. At the act of post-steps-receive 96, optionally steps to terminate the video communication are taken, such as terminating the communications path between the end points, reclaiming resources, storing preferences based on location or ar-marker 68 data used, ar-video-overlay 70, etc. Operationally, hand tracking with natural interactions techniques is provided by the other modules in the ar-computer 46, such as grab, point, pinch, swipe, etc. (actions you would use on real world objects). Holographic UI components such as buttons or elements are provided to assist in the set up and tear down of communications. In some embodiments the ar-displays are 3D Holographic-displays where 3D content includes surface tracking, and being able to attach content real world objects, specifically mirrors and ar-markers. In some embodiments, a touchpad provided at the ar-computer 46 enables user 58 input.

FIG. 14 is a front perspective view of FIG. 7b. A user 58 wearing an ar-eyewear 10 is looking at a mirror 60 in which the user 58, and consequently the ar-camera 11 of the ar-eyewear 10, sees: a reflection of first user 58 (reflection-user 64), a reflection of first ar-eyewear 10 (reflection-ar-eyewear 62).

FIG. 15 is a front perspective view of the of FIG. 10 illustrating (a) how a rectangular portion of a mirror 60 is seen as (a) an ar-video-overlay 70 by a left-eye 98 and a right-eye 100 through each of the ar-display 20 of ar-eyewear 10 and (b) an ar-bound-box 76 by the real camera 16 and a mirror 60 camera 16. In an embodiment, the ar-bound-box 76 and ar-video-overlay 70 are substantially the same size. In an embodiment, ar-video-overlay 70 is smaller or equal to the binocular-fov 36 of the ar-eyewear 10. In some embodiments, the ar-bound-box 76 is substantially the same size as the binocular-fov 36.

FIG. 16 is a front view of (a) the mirror 60 of FIG. 14, (b) the left-eye 98, right-eye 100, and a real ar-camera 44 view; and (c) an augmented left-eye 98, right-eye 100, and mirror-camera 102 view. As shown in FIG. 16A, the user 58 is ideally positioned normal to and centred relative to the mirror 60 to make the best use of the surface of the mirror 60. As shown in FIG. 16B, the user 58 has centred their own reflection in their left-fov 30, their right-toy 32 such that the ar-camera 11 is capable of capturing their own reflection. As shown in FIG. 16C, the ar-bound-box 76 has been determined to select the portion of the user 58 reflection for transmission thereby providing a mirror-camera 102. The ar-video-overlay 70 has been determined to coincide with the ar-bound-box 76 thereby enabling received video and transmitted video to be in similar aspect ratio.

Although not expressly shown in the drawings, in one embodiment, the ar-video-conference-module provides a device driver for the mirror-camera 102 wherein the ar-bound-box 76 has been applied to select the video of the ar-camera 44 such that the mirror-camera 102 can be utilised as if it were real with existing applications of the ar-computer 46. In one embodiment, the application is a standard video conferencing application. As used in this application, the terms video is a data structure stored in RAM and SSD, processed by CPU and GPU, and/or communicated over data networks, ane are meant to include either still or streams of moving images such that using the techniques of the present application to capture and communicate augmented reality still images is contemplated to be within the scope of this application. Likewise, in some embodiments, the use of an ar-camera having a depth-camera enables the video and still images to include 3D information. As used in this application, the terms ar-bound-box and ar-video-overlay are data structures that ultimately map to rectangular areas of a surface in 3 dimensional space on one hand, and to a region of a video feed of a camera on the other hand, and are stored in RAM and SSD, processed by CPU and GPU, and/or communicated over data networks.

Since other modifications and changes vaned to Fit particular operating requirements and environments will be apparent to those skilled in the art, the application is not considered limited to the example chosen for purposes of disclosure, and covers all changes and modifications which do not constitute departures from the true spirit and scope of this application.

What is claimed is:

1. A method of augmented reality communications involving at least one ar-computer connected to ar-eyewear having an ar-camera and an ar-display, the method comprising the acts of:
determining at least one data structure that delimits at least one portion of a field of view onto the surface of a mirror;
if the at least one data structure includes an ar-bound-box, then selecting the ar-camera video using the ar-bound-box and sending a formatted-ar-camera-video using the ar-bound-box; and
if the at least one data structure includes an ar-video-overlay, then receiving a received-video and displaying the received-video in the ar-video-overlay.

2. The method according to claim 1, further including pre-steps to one of the acts of sending or receiving, including at least one of signalling to establish a communications path between end points, configure ar-markers, configure facial recognition, configure camera calibration, and configure relative position of user interface elements.

3. The method according to claim 1, wherein the ar-bound-box delimits the portion of the field of view of the ar-camera that will be utilised to send the formatted-ar-camera-video.

4. The method according to claim 1, wherein the data structure is determined automatically by recognizing at the ar-computer using the ar-camera, one of: a reflection of the face of a user in a mirror, a reflection of the ar-eyewear in a mirror, and an ar-marker.

5. The method according to claim 1, wherein the data structure is determined manually by user manipulation of the information displayed in the ar-display including at least one of grab, point, pinch and swipe.

6. The method according to claim 1, further comprising the step of formatting the ar-camera video including at least one of correcting for alignment a mirror with the ar-camera and cropping the ar-camera video to include the portion that is delimited by the ar-bound-box.

7. The method according to claim wherein at least a portion of the data-structure positioned on he surface of a mirror.

8. The method according to claim 1, wherein the ar-video-overlay is dimensioned and positioned relative to a user of the ar-eyewear.

9. The method according to claim 1, further comprising post-steps to one of the acts of sending or receiving, including at least terminating the video communication, terminating the communication path between the end points, reclaiming resources, storing preferences based on one of location, ar-marker, data used, and ar-bound-box.

10. An ar video communication system suitable augmented reality communications over a data-communications-network, the system comprising;
an ar-eye-wear including at least one ar-display, and at least one ar-camera;
an ar-computer including at least an ar-video-communications-module and other-modules, the ar-computer connected with the ar-eyewear so as to enable the ar-video-communications-module and other module to use the ar-display and the ar-camera; and
wherein the ar-video-communications-module is configured for at least one of determining an ar-bound-box, selecting ar-camera video using an ar-bound-box, sending formatted-ar-camera-video, receiving video, determining an ar-video-overlay, and displaying video in an ar-video-overlay.

11. The ar video communication system according to claim 10, wherein the ar-eyewear further comprises at least one of a frame, a second ar-display, a left lens, a right lens, a sound-sensor, a left speaker, a right speaker, and a motion sensor.

12. The ar video communication system according to claim 10, wherein the ar-camera includes at least one of a camera and a depth-camera.

13. The ar video communication system according to claim 10, wherein the ar-computer further comprises at least one of a CPU, a GPU, a RAM, a storage drive, and other modules.

14. The ar video communication system according to claim 10, wherein the ar-video-communications-module provides a conventional camera device driver to enable applications operating in the ar-computer to use a mirror-camera as if it were a real-world camera.
